(19) United States
(12) Patent Application Publication
(10) Pub. No.: US 2026/0126751 A1
(43) Pub. Date: May 7, 2026

(54) IMAGE FORMING APPARATUS

(71) Applicant: KYOCERA Document Solutions Inc., Osaka (JP)

(72) Inventors: Shunsuke Sasaki, Osaka (JP); Minoru Shinba, Osaka (JP)

(21) Appl. No.: 19/379,078

(22) Filed: Nov. 4, 2025

(30) Foreign Application Priority Data
Nov. 7, 2024 (JP) 2024-194859

(51) Int. Cl. G03G 15/00; G03G 21/16

(52) U.S. Cl. CPC G03G 15/80; G03G 15/5004; G03G 15/5016; G03G 21/1633; G03G 21/1671; G03G 21/1676; G03G 2221/1606; G03G 2221/163; G03G 2221/169; G03G 2221/1823

(57) ABSTRACT

In an image forming apparatus, an image forming unit can be replaced. An outer cover becomes in an open status when the image forming unit is replaced. An inner cover becomes in an open status with a manual operation with taking a predetermined time after the outer cover becomes in an open status when the image forming unit is replaced. A cover open/close sensor detects open and close statuses of the outer cover. The image forming unit includes a non-volatile unit memory. Further, the controller (a) performs data communication with the unit memory, and (b) if data communication with the unit memory is ongoing when the cover open/close sensor detects that the outer cover becomes in an open status, completes the data communication and cuts off power supply to the image forming unit before the predetermined time elapses.

### CROSS-REFERENCE TO RELATED APPLICATIONS

This application relates to and claims priority rights from Japanese Patent Application No. 2024-194859, filed on Nov. 7, 2024, the entire disclosures of which are hereby incorporated by reference herein.

### BACKGROUND

### 1. Field of the Present Disclosure

The present disclosure relates to an image forming apparatus.

### 2. Description of the Related Art

An image forming apparatus includes a drum cartridge that includes a photoconductor drum and a drum memory. In this image forming apparatus, the drum cartridge can be replaced; and in order to restrain trouble of the drum memory due to hot swapping of the drum cartridge, if communication with the drum memory is being performed when a cover becomes in an open status, the communication with the drum memory is immediately stopped and power supply to the drum cartridge is stopped.

However, in the aforementioned image forming apparatus, if communication with the drum memory is being performed when a cover becomes in an open status, then the communication with the drum memory is suspended, and therefore, data to be written into the drum memory may not be completely written or data to be read from the drum memory may not be completely read.

### SUMMARY

An image forming apparatus according to an aspect of the present disclosure includes an image forming unit that can be replaced, an outer cover, an inner cover, a cover open/close sensor, and a controller. The outer cover is configured to become in an open status when the image forming unit is replaced. The inner cover is configured to become in an open status with a manual operation after the outer cover becomes in an open status when the image forming unit is replaced, and the inner cover becoming in the open status with taking a predetermined time after the outer cover becomes in the open status. The cover open/close sensor is configured to detect open and close statuses of the outer cover. The image forming unit includes a non-volatile unit memory. Further, the controller (a) performs data communication with the unit memory, and (b) if data communication with the unit memory is ongoing when the cover open/close sensor detects that the outer cover becomes in an open status, completes the data communication and cuts off power supply to the image forming unit before the predetermined time elapses.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image forming apparatus according to an embodiment of the present disclosure;

FIG. 2 shows a perspective-view diagram that indicates an example of an outer cover 21 shown in FIG. 1;

FIG. 3 shows a perspective-view diagram that indicates an example of an inner cover 22 shown in FIG. 1; and

FIG. 4 shows a flowchart that explains a behavior of the image forming apparatus shown in FIGS. 1 to 3.

### DETAILED DESCRIPTION

Hereinafter, an embodiment according to an aspect of the present disclosure will be explained with reference to drawings.

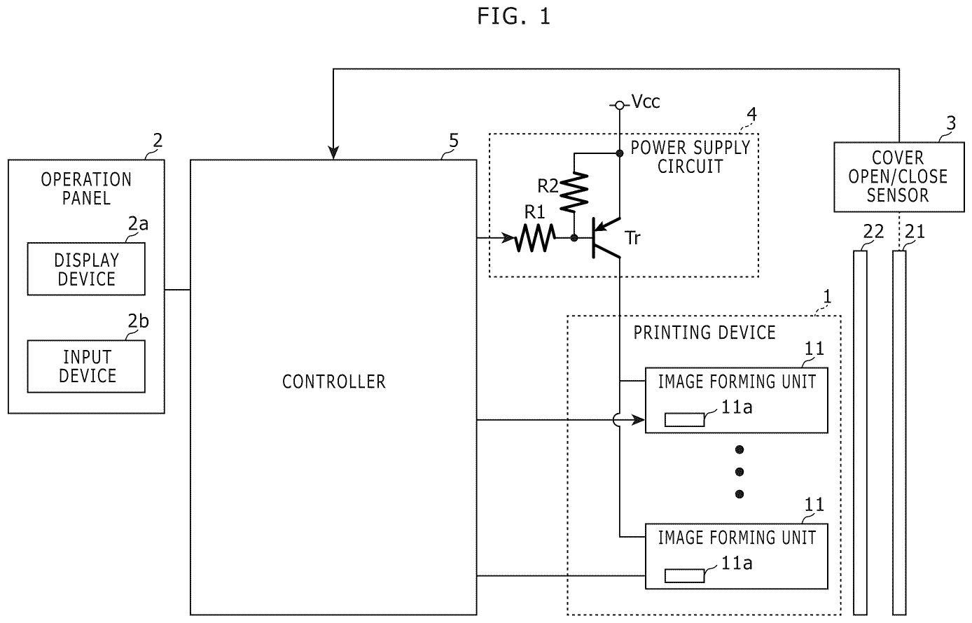

FIG. 1 shows a block diagram that indicates a configuration of an image forming apparatus according to an embodiment of the present disclosure. The image forming apparatus shown in FIG. 1 is, for example, an image forming apparatus such as a multi function peripheral. The image forming apparatus shown in FIG. 1 includes a printing device 1, an operation panel 2, a cover open/close sensor 3, a power supply circuit 4, and a controller 5.

The printing device 1 transports a print sheet from a sheet feeding cassette and prints on the print sheet an image based on image data in an electrographic manner. Specifically, the printing device 1 includes photoconductor drums, exposure devices that expose the photoconductor drums and thereby form electrostatic latent images, development devices that attach toner to the electrostatic latent images on the photoconductor drums and thereby form toner images, a fuser that fixes the toner images transferred onto the print sheet, and the like.

The photoconductor drum or the development device is included in an image forming unit 11 that can be replaced. For example, in case of a color image forming apparatus of 4 colors CMYK, the image forming apparatus includes 8 image forming units 11 for the photoconductor drums and the development devices. Here, each of the image forming units 11 is either a drum unit that includes the photoconductor drum or a development unit that includes the development device. Each of the image forming units 11 includes a non-volatile unit memory 11a, and in the unit memory 11a, stored are (a) a driving distance or the like that indicates replacement timing of this unit 11, (b) image forming characteristic data of this unit 11 and the like, for example.

Furthermore, the operation panel 2 includes a display device 2a such as a liquid crystal display, that displays sorts of screens to a user, and an input device 2b such as a touch panel or a hard key, that receives a user operation.

The cover open/close sensor 3 is a sensor that detects open and close statuses of an outer cover 21 mentioned below.

The power supply circuit 4 is a circuit that turns on and off power supply to the image forming unit 11 in accordance with a control signal from the controller 5. Here, the power supply circuit 4 includes a transistor Tr as a switching element connected to a power supply Vcc and a voltage divider circuit that consists of resistors R1 and R2. If the control signal from the controller 5 takes a low level, the transistor Tr becomes in an ON status, and electric power is supplied to the image forming unit 11 through the transistor Tr; and if the control signal from the controller 5 takes a high level, the transistor Tr becomes in an OFF status, and supplying electric power to the image forming unit 11 is cut off by the transistor Tr.

Further, the controller 5 receives job requests for sorts of jobs, and upon receiving a job request, performs a job specified by the job request. For example, the controller 5 receives a job request for a print job, and upon receiving the job request, performs a data process (raster process and/or the like) and/or an image process (screen process and/or the like) for image data specified by the job request and thereby generates image data for printing, and performs the print job using the printing device 1 on the basis of the generated image data.

The controller 5 includes an ASIC (Application Specific Integrated Circuit) and a computer that includes a CPU (Central Processing Unit), a ROM (Read Only Memory), a RAM (Random Access Memory) and the like and executes a predetermined program and the like, and performs various processes using the ASIC, the computer and/or the like.

Further, the controller 5 performs data communication with the unit memory 11a (i.e. read or write of data as mentioned). This data communication is wired data communication, for example, and is performed through a connector physically connected when the image forming unit 11 is mounted.

Furthermore, the image forming apparatus shown in FIG. 1 includes outer and inner covers 21 and 22 that become in open statuses when the image forming unit 11 is replaced. The inner cover 22 becomes in an open status with a manual operation after the outer cover 21 becomes in an open status when the image forming unit 11 is replaced, and the inner cover 22 becomes in the open status with taking a predetermined time after the outer cover 21 becomes in the open status. It should be noted that the inner cover 22 does not become in an open status while the outer cover 21 is not in an open status.

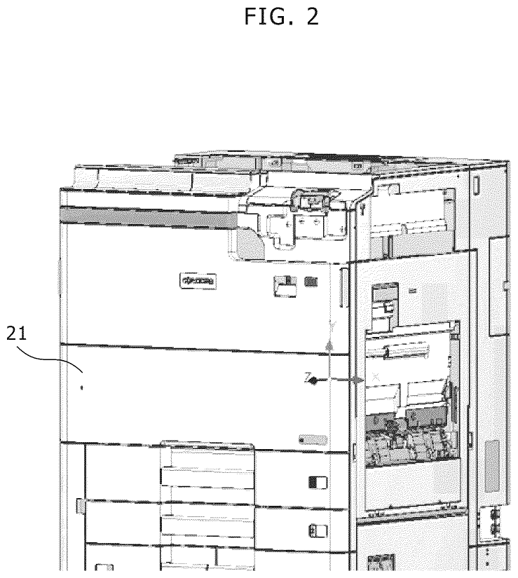

FIG. 2 shows a perspective-view diagram that indicates an example of an outer cover 21 shown in FIG. 1. As shown in FIG. 2, for example, the outer cover 21 is installed as a part of a housing of the image forming apparatus.

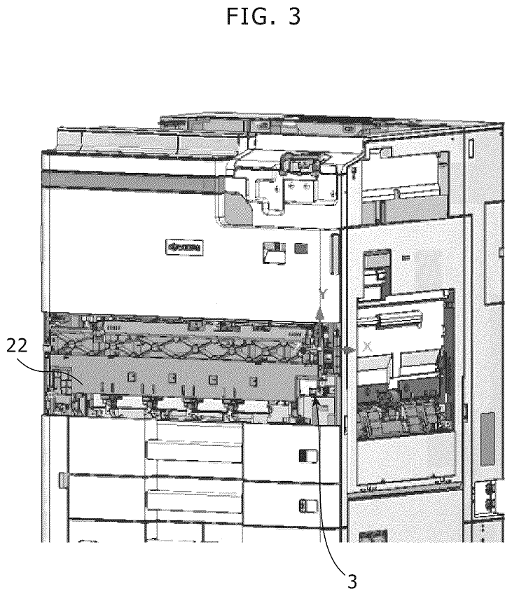

FIG. 3 shows a perspective-view diagram that indicates an example of an inner cover 22 shown in FIG. 1. As shown in FIG. 3, for example, the inner cover 22 is installed inside of the housing, and presses and fixes the image forming unit 11 (here, all of the image forming units 11); and when the inner cover 22 becomes in an open status, the image forming unit 11 can be physically removed.

Further, if data communication with the unit memory 11 is ongoing when the cover open/close sensor 3 detects that the outer cover 21 becomes in an open status, then before the aforementioned predetermined time elapses, the controller 5 completes the data communication and controls the power supply circuit 4 and thereby cuts off power supply to the image forming unit 11. Thus, before the inner cover 22 becomes in an open status by a manual operation, the data communication with the unit memory 11 is completed without suspension, and power supply to the image forming unit 11 is cut off, and therefore, hot swapping is restrained without damage of data read/written from/to the unit memory 11a. For example, the controller 5 sets a data amount of the data communication such that the data communication can be completed within the aforementioned predetermined time.

Further, in this embodiment, when the cover open/close sensor 3 detects that the outer cover 21 becomes in an open status, the controller 5 displays on the display device 2a a message (warning) that (a) indicates that the outer cover 21 is in an open status and (b) prompts to make the outer cover 21 be in a close status.

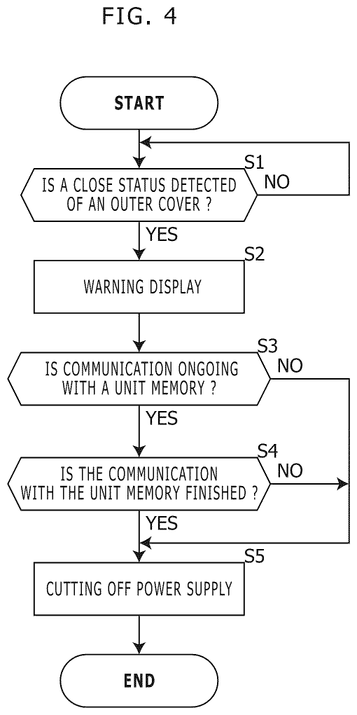

The following part explains a behavior of the aforementioned image forming apparatus. FIG. 4 shows a flowchart that explains a behavior of the image forming apparatus shown in FIGS. 1 to 3.

When replacing the image forming unit 11, a user firstly opens outer cover 21.

Correspondingly to it, when an open status of the outer cover 21 is detected (in Step S1), the controller 5 performs displaying of warning as mentioned (in Step S2) and determines whether data communication with the unit memory 11a is ongoing or not (in Step S3).

If it is determined that the data communication with the unit memory 11a is ongoing, then within a predetermined time, the controller 5 continues the data communication with the unit memory 11a, and upon determining that this data communication is completed (in Step S4), cuts off power supply to the image forming unit 11 using the power supply circuit 4 (in Step S5).

Contrarily, if it is determined that the data communication with the unit memory 11a is not ongoing, then the controller 5 immediately cuts off power supply to the image forming unit 11 using the power supply circuit 4 (in Step S5).

Meanwhile, after the user opens the outer cover 21, the user opens the inner cover 22 with taking the aforementioned predetermined time, and thereafter, removes the image forming unit 11 and mounts a new image forming unit 11. Here, at a time point that the inner cover 22 is opened, power supply to the image forming unit 11 is in a cutoff status, and therefore, how swapping is restrained.

As mentioned, in the aforementioned embodiment, this image forming apparatus includes not only the outer cover 21 but the inner cover 22 that becomes in an open status with a manual operation with taking a predetermined time after the outer cover 21 becomes in an open status when the image forming unit 11 is replaced. The controller 5 performs data communication with the unit memory 11a in the image forming unit 11. Further, if data communication with the unit memory 11a is ongoing when the cover open/close sensor 3 detects that the outer cover 21 becomes in an open status, then before the aforementioned predetermined time elapses, the controller 5 completes the data communication and cuts off power supply to the image forming unit 11.

Consequently, removal of the image forming unit 11 is delayed due to a manual operation to the inner cover 22, and therefore, while hot swapping of the image forming unit 11 is restrained, data write or data read to/from the unit memory 11a in this image forming unit 11 is properly performed.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming apparatus, comprising:
an image forming unit that can be replaced;
an outer cover configured to become in an open status when the image forming unit is replaced;
an inner cover configured to become in an open status with a manual operation after the outer cover becomes in an open status when the image forming unit is replaced, and the inner cover becoming in the open status with taking a predetermined time after the outer cover becomes in the open status;
a cover open/close sensor configured to detect open and close statuses of the outer cover; and
a controller;
wherein the image forming unit comprises a non-volatile unit memory; and
the controller (a) performs data communication with the unit memory, and (b) if data communication with the unit memory is ongoing when the cover open/close sensor detects that the outer cover becomes in an open status, completes the data communication and cuts off power supply to the image forming unit before the predetermined time elapses.

2. The image forming apparatus according to claim 1, further comprising a display device;
wherein when the cover open/close sensor detects that the outer cover becomes in an open status, the controller displays on the display device a message that (a) indicates that the outer cover is in an open status and (b) prompts to make the outer cover be in a close status.

3. The image forming apparatus according to claim 1, wherein the controller sets a data amount of the data communication such that the data communication can be completed within the predetermined time.

4. The image forming apparatus according to claim 1, wherein the image forming unit is either a drum unit that comprises a photoconductor drum or a development unit that comprises a development device that adheres toner to an electrostatic latent image on a photoconductor drum.
